(19) United States
(12) Patent Application Publication
(10) Pub. No.: US 2015/0261892 A1
(43) Pub. Date: Sep. 17, 2015

(54) INTEGRATED OPTIMAL PLACEMENT, SIZING, AND OPERATION OF ENERGY STORAGE DEVICES IN ELECTRIC DISTRIBUTION NETWORKS

(71) Applicant: NEC Laboratories America, Inc., Princeton, NJ (US)

(72) Inventors: Mohammad C. Bozchalui, Cupertino, CA (US); Ratnesh Sharma, Fremont, CA (US); Ali Hooshmand, Campbell, CA (US)

(21) Appl. No.: 14/562,915

(22) Filed: Dec. 8, 2014

Related U.S. Application Data
(60) Provisional application No. 61/951,674, filed on Mar. 12, 2014.

(51) Int. Cl. G06F 17/50; G06F 17/10

(52) U.S. Cl. CPC G06F 17/5004; G06F 17/10

(57) ABSTRACT

A method and system are provided. The method includes co-optimizing a placement, a sizing, and an operation schedule of at least one energy storage system in an energy distribution system. The energy distribution system further has at least one renewable energy resource and at least one distributed energy resource. The co-optimizing step includes generating a placement-sizing-scheduling co-optimization model of the at least one energy storage system by integrating therein a distribution optimal power flow optimization model of the energy distribution system and components thereof. The distribution optimal power flow optimization model integrates therein at least an energy storage system model, a renewable energy resource model, and a distributed energy resource model. The co-optimizing step further includes optimally determining, using a processor-based placement-sizing-scheduling optimizer, the placement, the sizing, and the operation schedule of the at least one energy storage system based on the placement-sizing-scheduling co-optimization model.

This application claims priority to provisional application Ser. No. 61/951,674 filed on Mar. 12, 2014, incorporated herein by reference.

### BACKGROUND

1. Technical Field

The present invention relates to energy, and more particularly to integrated optimal placement, sizing, and operation of energy storage devices in electric distribution networks.

2. Description of the Related Art

Efficient, economic, and sustainable operation of distribution networks in emerging smart grids attain a particular importance as the integration of Renewable Energy Resources (RERs) with intermittent power outputs brings new challenges to the operation of these systems. On the other hand, Distributed Energy Resources (DERs), Distributed Generations (DGs), and Energy Storage Systems offer promising potentials for more efficient operation of distribution networks. In this context, Energy Storage Systems can deal with the intermittent nature of RERs, improve system reliability and grid utilization, reduce energy loss, and lower system peak demand. However, due to the high capital costs of Energy Storage Systems, it is vital to properly size and operate Energy Storage Systems to maximize their impact on the efficiency of distribution networks and microgrids.

Typically, depending on the application considered for the Energy Storage Systems, these devices are placed at the upstream substation. For example, the Energy Storage Systems can be placed at the end of the feeder or nearby major sources of intermittent resources such as solar PhotoVoltaics (PVs) and wind generation plants. Common approaches to placement are using rule-based approaches for each application or evaluating multiple options using traditional power-flow based techniques. Different sizes of Energy Storage Systems are considered and a Monte-Carlo type of analysis is carried out to find the more appropriate size of the Energy Storage Systems for the given application. For operation scheduling, rule-based approaches such as time of day or load level based methods are common ways of operation scheduling of ESS in energy systems. Simple load following approaches, time triggered constant discharge, or simple peak shaving methods are used by others to schedule the operation of the Energy Storage Systems in power distribution systems. Others have also used conventional power flow techniques to run multiple scenarios and schedule the operation of Energy Storage Systems based on off-line analysis of the results. Existing optimization based methods in the literature use an approximate models of the systems such as balanced model or phase-decouple model of the system to operate Energy Storage Systems in power distribution systems.

### SUMMARY

These and other drawbacks and disadvantages of the prior art are addressed by the present principles, which are directed to integrated optimal placement, sizing, and operation of energy storage devices in electric distribution networks.

According to an aspect of the present principles, a method is provided. The method includes co-optimizing a placement, a sizing, and an operation schedule of at least one energy storage system in an energy distribution system. The energy distribution system further has at least one renewable energy resource and at least one distributed energy resource. The co-optimizing step includes generating a placement-sizing-scheduling co-optimization model of the at least one energy storage system by integrating therein a distribution optimal power flow optimization model of the energy distribution system and components thereof. The distribution optimal power flow optimization model integrates therein at least an energy storage system model modeling the at least one energy storage system, a renewable energy resource model modeling the at least one renewable energy resource, and a distributed energy resource model modeling the at least one distributed energy resource. The co-optimizing step further includes optimally determining, using a processor-based placement-sizing-scheduling optimizer, the placement, the sizing, and the operation schedule of the at least one energy storage system based on the placement-sizing-scheduling co-optimization model.

According to another aspect of the present principles, a co-optimization system is provided for co-optimizing a placement, a sizing, and an operation schedule of at least one energy storage system in an energy distribution system, the energy distribution system further having at least one renewable energy resource and at least one distributed energy resource. The co-optimization system includes a memory. The co-optimization system further includes at least one processor device, coupled to the memory, operative to generate a placement-sizing-scheduling co-optimization model of the at least one energy storage system by integrating therein a distribution optimal power flow optimization model of the energy distribution system and components thereof. The distribution optimal power flow optimization model integrates therein at least an energy storage system model modeling the at least one energy storage system, a renewable energy resource model modeling the at least one renewable energy resource, and a distributed energy resource model modeling the at least one distributed energy resource. The at least one processor device is further operative to optimally determine the placement, the sizing, and the operation schedule of the at least one energy storage system based on the placement-sizing-scheduling co-optimization model.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary processing system 100 to which the present principles may be applied, in accordance with an embodiment of the present principles;

FIG. 2 shows an exemplary system 200 for integrated optimal placement, sizing, and operation of energy storage devices in an electric distribution network, in accordance with an embodiment of the present principles.

FIG. 3 shows an exemplary method 300 for integrated optimal placement, sizing, and operation of energy storage devices in an electric distribution network, in accordance with an embodiment of the present principles; and

FIG. 4 shows an exemplary architecture 400 for integrated placement, sizing, and operation of energy storage devices in an electric distribution network, in accordance with an embodiment of the present principles.

### DETAILED DESCRIPTION OF PREFERRED EMBODIMENTS

The present principles are directed to integrated optimal placement, sizing, and operation of energy storage devices in electric distribution networks.

In an embodiment, the present principles provide a method to optimally place, size, and operate Energy Storage Systems in distribution networks with Renewable Energy Resources (RERs) and Distributed Energy Resources (DERs) to improve the efficiency of power distribution systems.

The present principles provide a novel integrated methodology for optimal placement, sizing, and operation of Energy Storage Systems in distribution systems that can be used in radial and meshed unbalanced distribution networks. In an embodiment, the present principles involve a comprehensive mathematical optimization modeling of distribution networks with Renewable Energy Resources, Distributed Energy Resources, and Energy Storage Systems. The present principles optimally place, size, and schedule the operation of the Energy Storage System while satisfying the operational requirements of the distribution network and other components in the electric distribution system. A mathematical model is developed for the Energy Storage System that captures operational aspects as well as power flow models, and incorporated in a nodal three-phase unbalanced Distribution Optimal Power Flow (DOPF) optimization problem formulation. The present principles includes detailed models of Distributed Energy Resources and an Energy Storage System model can be placed at any node and in any phase of an unbalanced electric network. This formulation is generic and models optimal active and reactive power aspects of distribution systems and microgrids as well as regulating the network voltages. This mathematical optimization formulation is used in the developed integrated method to optimally place, size, and operate ESS in distribution networks and microgrids. The present principles include many attendant advantages/objectives including, but not limited to, improving efficiency of distribution networks, reducing losses, minimizing peak demand, minimizing imbalanced power at the point of connection to another grid, minimizing energy withdrawn from the grid, and minimizing peak to average ratio.

Electric distribution systems designers and operators can use any one or combinations of these advantages/objectives to find the best solution in any power distribution system. The present principles can also be used for operational studies, impact studies, and analysis of the system under study. The preceding can involve, but are not limited to, the voltage profile at each node, feeder currents, losses, energy drawn from the substation, tap and capacitor operations, and so forth. The present principles can also be used for power flow analysis and for optimal power flows in an unbalanced distribution network. Thus, the present principles provide a general framework that incorporates various objectives and constraints related to reliable and optimal operation of power distribution systems.

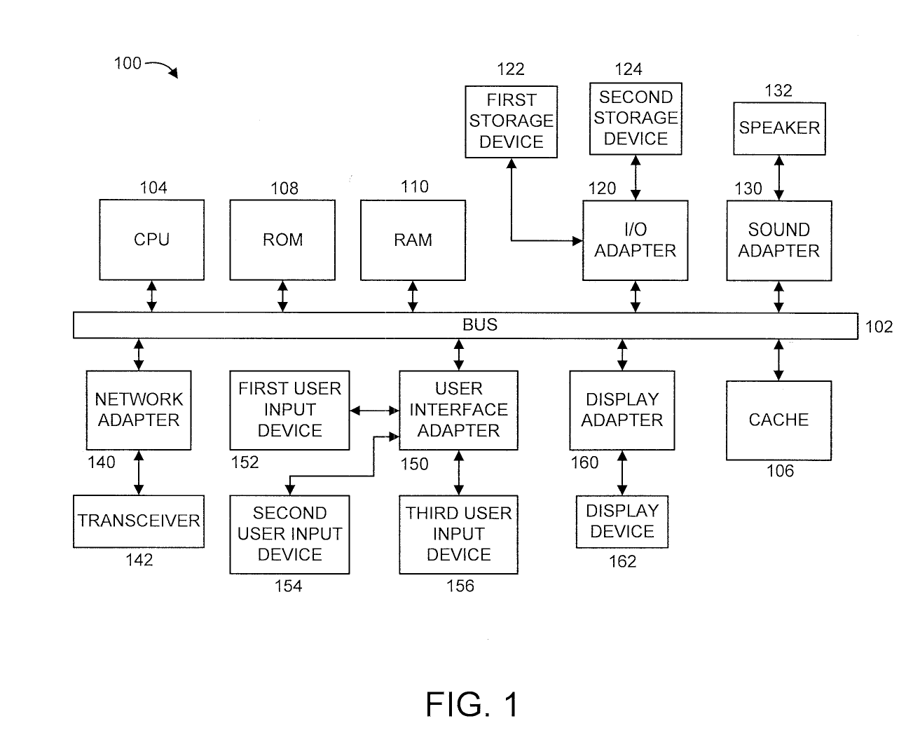

FIG. 1 shows an exemplary processing system 100 to which the present principles may be applied, in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

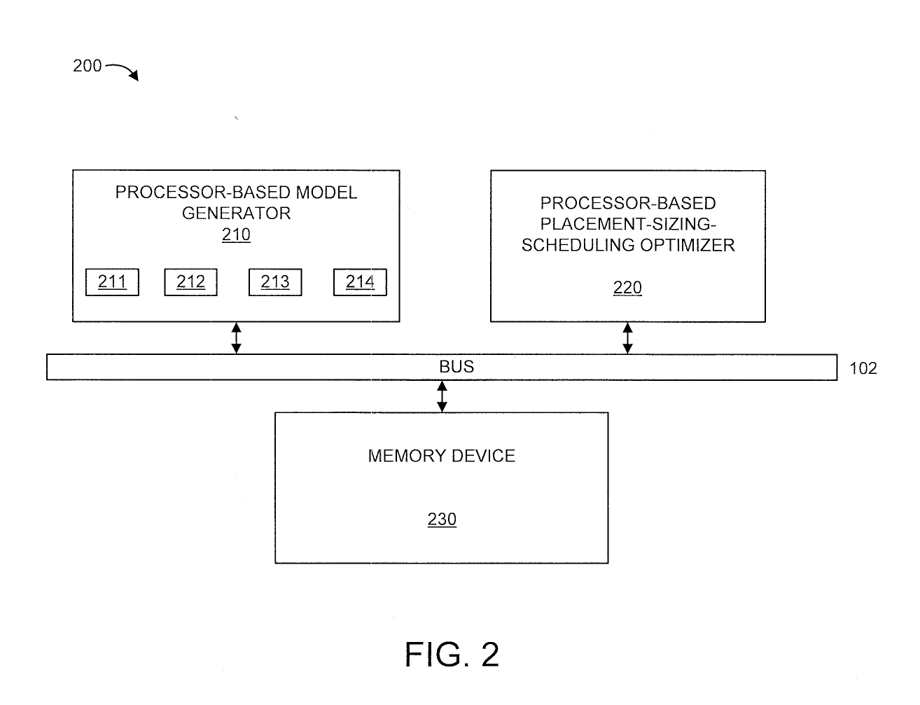

Moreover, it is to be appreciated that system 200 described below with respect to FIG. 2 is a system for implementing respective embodiments of the present principles. Part or all of processing system 100 may be implemented in one or more of the elements of system 200.

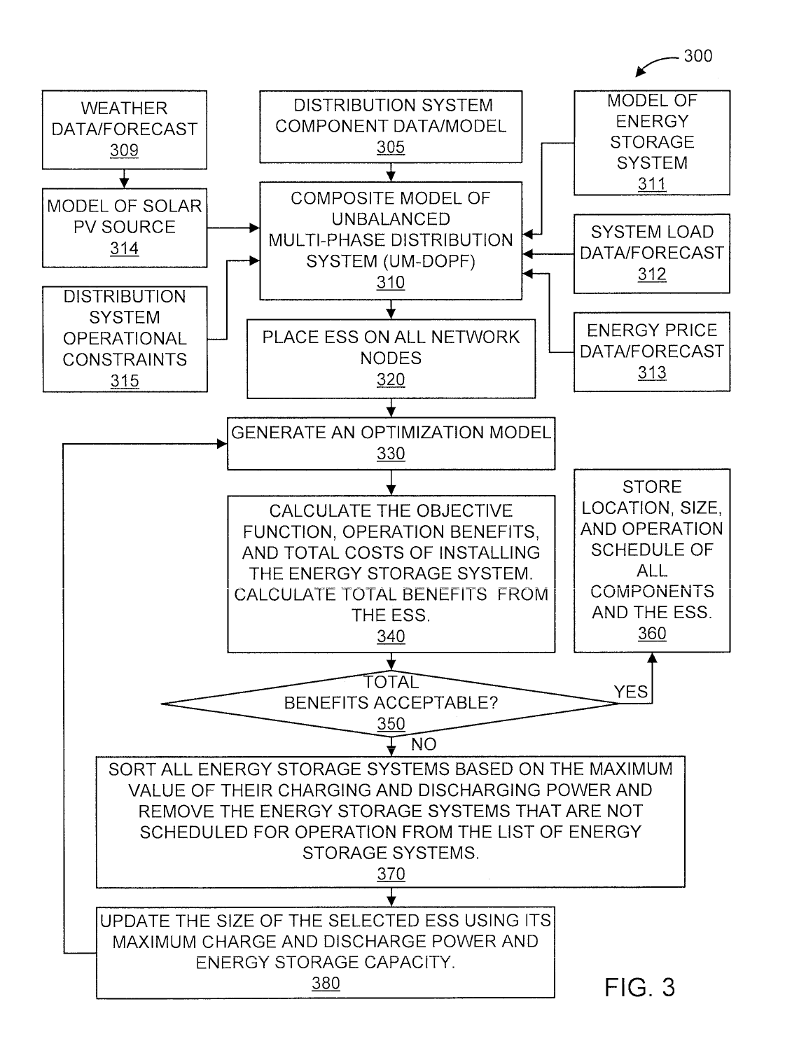

Further, it is to be appreciated that processing system 100 may perform at least part of the method described herein including, for example, at least part of method 300 of FIG. 3. Similarly, part or all of system 200 may be used to perform at least part of method 300 of FIG. 3.

FIG. 2 shows an exemplary system 200 for integrated optimal placement, sizing, and operation of energy storage devices in an electric distribution network, in accordance with an embodiment of the present principles. System 200 is interchangeably referred to herein as a co-optimization system.

The system 200 includes a processor-based model generator 210, a processor-based placement-sizing-scheduling optimizer 220, and a memory device 230.

The processor-based model generator 210 generates various models used in accordance with the present principles including, but not limited to, a mathematical model of a PV source(s), a mathematical model of an Energy Storage System(s), a mathematical model for an unbalanced multi-phase distribution system with distributed energy resources, and a placement-sizing-scheduling co-optimization model. In the embodiment of FIG. 2, the processor-based model generator 210 includes a PV model generator 211, an ESS model generator 212, a distribution system (e.g., UM-DOPF) model generator 213, and a placement-sizing-scheduling co-optimization model generator 214 for generating the preceding models.

The processor-based placement-sizing-scheduling optimizer 220 optimally determines the placement, sizing, and operation schedule of at least one energy storage system based on the placement-sizing-scheduling co-optimization model. To that end, the optimizer 220 can calculate objective functions, operation benefits, and total costs of, e.g., installing an Energy Storage System and so forth. The optimizer 220 can also determine, e.g., if the benefits and total costs are acceptable. The optimizer 220 can also perform sorting of the Energy Storage Systems as described herein.

The memory device 230 stores information relating to the placement, sizing, and operation of energy storage devices and systems.

In the embodiment shown in FIG. 2, the elements thereof are interconnected by a bus 201. However, in other embodiments, other types of connections can also be used. Further, while the PV model generator 211, ESS model generator 212, distribution system model generator 213, and placement-sizing-scheduling co-optimization model generator 214 are shown as part of the processor-based model generator 210, in another embodiment one or more of these elements can be implemented as standalone elements. These and other variations of the elements of system 200 are readily determined by one of ordinary skill in the art, given the teachings of the present principles provided herein, while maintaining the spirit of the present principles.

FIG. 3 shows an exemplary method 300 for integrated optimal placement, sizing, and operation of energy storage devices in an electric distribution network, in accordance with an embodiment of the present principles.

At step 305, input distribution system data. The distribution system data can include, but is not limited to, network configuration, connections, conductors/cables, transformers, switches, energy storage, capacitors, and so forth.

At step 310, build the mathematical model for the unbalanced multi-phase distribution system with distributed energy resources (UM-DOPF). In an embodiment, step 310 can include the following steps 311-315. At step 311, input a mathematical model of the Energy Storage System. At step 312, input load data/forecast. At step 313, input energy price data/forecast. At step 314, input a mathematical model of a solar PV source. In an embodiment, step 314 can include step 309. At step 309, input weather data/forecast. At step 315, input the power distribution system operator's settings (e.g., but not limited to, voltage limits).

At step 320, place the Energy Storage System (e.g., with a size within acceptable size limits) on all nodes of the network. In an embodiment, step 320 can include the following step 321. At step 321, input objectives such as total costs, peak demand, losses, imbalance power, resource efficiency objectives as captured by the cost of resources, and so forth.

At step 330, generate an optimization model (also interchangeably referred to herein as a “placement-sizing-scheduling co-optimization model”). In an embodiment, step 330 can involve one or more of the following: selecting an objective function; including the UM-DOPF model; adding the selected Energy Storage System to the model; solving the optimization model for {t . . . T} on a computing machine (e.g., standalone computer or embedded single board computer); and generating an optimal schedule for the distribution network components and the Energy Storage System.

At step 340, calculate the objective function, operation benefits, and total costs of installing the Energy Storage System. Also, calculate the total benefits from the Energy Storage System.

At step 350, determine if the total benefits are acceptable (e.g., based on certain criteria). If so, then the method continues to step 360. Otherwise, the method continues to step 370.

At step 360, store the location, size, and operation schedule of all the components and the Energy Storage System.

At step 370, sort all of the Energy Storage Systems based on the maximum value of their charging or discharging power and remove the Energy Storage Systems that are not scheduled for operation from a list of Energy Storage Systems.

At step 380, update the size of the selected Energy Storage System using its maximum charge and discharge power and energy storage capacity including ramp capability.

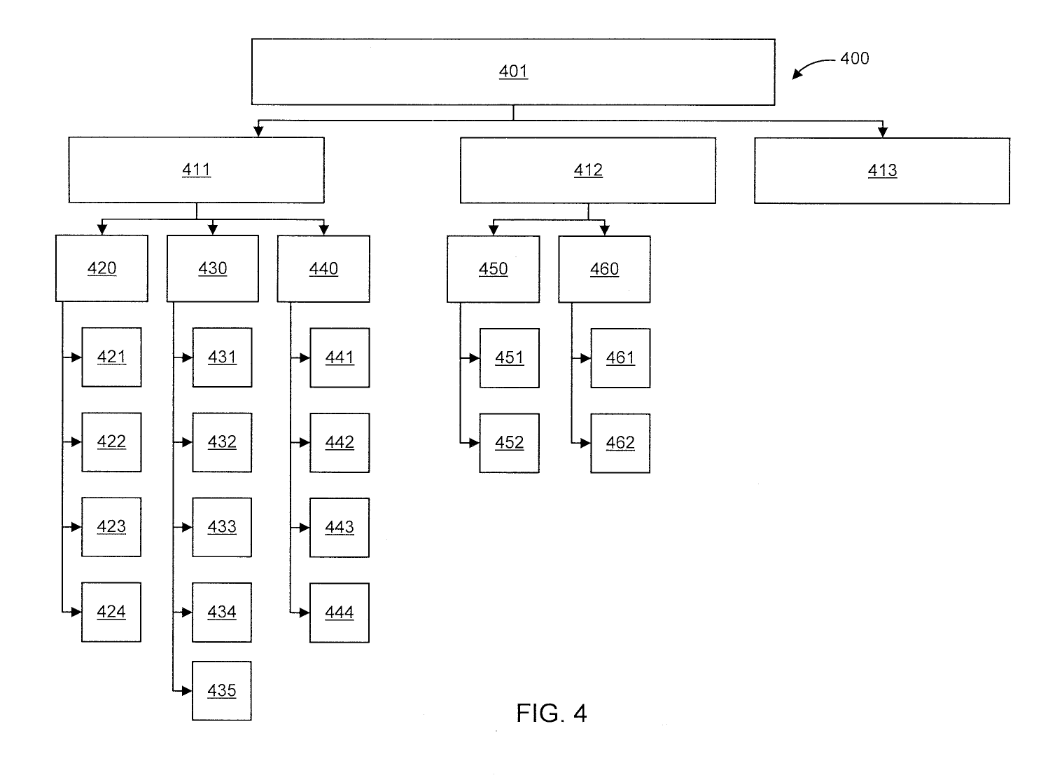

FIG. 4 shows an exemplary architecture 400 for integrated placement, sizing, and operation of energy storage devices in an electric distribution network, in accordance with an embodiment of the present principles.

The architecture 400 involves co-optimization 401 of ESS placement, sizing, and operation scheduling in an electric distribution network.

The co-optimization 401 involves mathematical modeling 411 of the electric distribution network and its components, optimization techniques 412, and applications 413.

The mathematical modeling 411 can involve energy storage systems 420, objective functions 430, electric distribution network modeling 440 for ESS placement, sizing, and operation, Non-Linear Programming (NLP) problem formulation 450, and semi-definite programming 460.

The energy storage systems 420 can involve a single-phase controlled ESS model 421, a capability chart of the energy storage converter 422, charge/discharge constraints of the ESS 423, losses due to the supply of reactive power 424. In an embodiment, an optimization model can be used to determine the optimal charging/discharging/idling schedule of the ESS.

The objection function 430 can involve modeling converter losses 431, peak demand 432, energy consumption 433, unbalanced power at the point of connection 434, and total costs 435.

The electric distribution network modeling 440 can involve multi-phase unbalanced distribution system modeling 441, using rectangular and polar values of current and voltages 442, modeling of DERs and RERs 443, and optimization formulation for ESS placement and sizing 444.

The NPL problem formulation 450 can involve a single objective 451 and a multi-objective optimization 452.

The semi-definite programming 460 can involve a single objective 461 and a multi-objective optimization 462.

Further regarding the single-phase controlled ESS model 421, the ESS can be modeled as a source when in a discharging mode and as a load when in a charging mode. The ESS operation can be distinguished by the sign of the output power, where a positive sign denotes discharging and a negative sign denotes a charging mode operation. This output power is integrated into the power flow equations of the network. In an embodiment, the ESS model constraints can be as follows:

$$\begin{matrix}{x}_{es , t} = \{ \begin{matrix}b , & if t = 0 \\ b , & if t = T \\ {x}_{es , t - 1} - {p}_{es , t}^{dis} Δ t , & otherwise\end{matrix} & ( 1 ) \\ {\underline{X}}_{es} < {x}_{es , t} < {\overline{X}}_{es} & ( 2 )\end{matrix}$$

Further regarding the capability chart of the energy storage converter 422, in an embodiment, the acceptable operation region for the energy storage converter is modeled as follows:

Pₑₛ≦vv_{es,t}^{r}i_{es,t}^{r}+v_{es,t}ⁱi_{es,t}ⁱ≦ P̅ₑₛ (3)

Qₑₛ≦vv_{es,t}ⁱi_{es,t}^{r}−v_{es,t}^{r}i_{es,t}ⁱ≦ Q̅ₑₛ (4)

(P_{es,t})²+(Q_{es,t})²≦|Sₑₛ^{max}|² (5)

Active and reactive power outputs of the ES converter can be as follows:

p_{es,t}≦v_{es,t}^{r}i_{es,t}^{r}+v_{es,t}ⁱi_{es,t}ⁱ (6)

q_{es,t}≦v_{es,t}ⁱi_{es,t}^{r}−v_{es,t}ⁱi_{es,t}ⁱ (7)

Further regarding the charge/discharge constraints of the ESS 423, in an embodiment, the same can be modeled as follows:

p_{es,t}^{dis}=v_{es,t}^{r}i_{es,t}^{r}+v_{es,t}ⁱi_{es,t}ⁱ)+((i_{es,t}^{r})²+(i_{es,t}ⁱ)²)Rₑₛ (8)

Further regarding modeling losses of the ESS due to the supply of reactive power 424, in an embodiment, the same can be modeled as follows:

p_{es,t}^{loss}=((i_{es,t}^{r})²+(i_{es,t}ⁱ)²)Rₑₛ (9)

Further regarding modeling converter losses 431, in this case, in addition to active power losses in the distribution network branches (i.e., lines and transformers), losses from energy storage devices are also included in the objective function. Thus, total losses of the distribution system are formulated as follows:

$$\begin{matrix}{p}_{loss} = \sum [ real ( {V}_{n} {I}_{n , m}^{*} - {V}_{m} {I}_{n , m}^{*} ) ] + {p}_{es}^{loss} \\ = \sum [ ( {V}_{n}^{r} - {V}_{m}^{r} ) {I}_{n , m}^{r} + ( {V}_{n}^{i} - {V}_{m}^{i} ) {I}_{n , m}^{i} ] + {p}_{es}^{loss}\end{matrix} \qquad ( 10 \text{-} 1 )$$

where I_{n,m}^{r}, I_{n,m}ⁱ represent real and imaginary parts of currents flowing from node n to node m, and losses of energy storage devices are calculated using Equation (9).

Further regarding the inclusion of peak demand 432, in an embodiment, in order to minimize peak demand of the system over the scheduling horizon at the substation or point of connection (POC) to the grid, a new variable and a set of extra constraints are added to the optimization problem. Active power drawn from the grid at n=POC, time t, and phase k can be represented as follows:

P_{poc,t,k}=v_{n,t,k}^{r}i^{r}_{(n,m),t,k}+v_{n,t,ki}ⁱiⁱ_{(n,m),t,k} ∀kε{a,b,c} (10-2)

Peak demand of the system over scheduling horizon is calculated as follows:

Pₚₑₐₖ≧Σ_{kε{a,b,c}}p_{poc,t,k} ∀tε{1 . . . T} (10-3)

Thus, the objective function is defined as follows:

J=pₚₑₐₖ (10-4)

Further regarding energy consumption 433, the total energy drawn from the utility at the POC is calculated as follows:

J=Σₜ₌₁^{T}Σ_{kε{a,b,c}}p_{poc,t,k} (10-5)

where p_{poc,t,k} is total active power drawn from POC at time t and phase k.

Further regarding the multi-phase unbalanced distribution system modeling 441, the same can involve modeling a three-phase unbalanced distribution system using the following models in optimization-based operation scheduling of ESS in an electric distribution network. Regarding such models, the sum of currents injected and withdrawn from each node is equal to zero, and can be written in the matrix form for an electrical circuit as follows:

$$\begin{matrix}[ I ] = [ Y ] [ V ] & ( 10 ) \\ [ \begin{matrix}{I}^{r} \\ {I}^{i}\end{matrix} ] = [ \begin{matrix}G & - B \\ B & G\end{matrix} ] [ \begin{matrix}{V}^{r} \\ {V}^{i}\end{matrix} ] & ( 11 ) \\ {I}_{n} = {\sum }_{l = 1}^{L} {\overline{I}}_{n , l} & ( 12 )\end{matrix}$$

where [Y] is the admittance matrix of the system, G is the bus conductance matrix, G is the bus susceptance matrix, [I] is the vector of net current injection at each node, [V] is the vector of voltages at each node, V^{r} and Vⁱ are the vectors of real and imaginary components of voltage V, Iₙ is complex current injection at node n, Iₙ, Ī_{n,l} is the complex current injection from component l connected to node n, and L is total number of components connected to node n.

Further regarding using rectangular and polar values of current and voltages 442, voltage magnitudes at each node should always remain within acceptable limits as follows:

(V^{min})²≦V^{r}V^{r}·V^{r}+Vⁱ·Vⁱ≦|V^{max}|² (13)

where V^{max} and V^{min} are the upper and lower limits on node voltages.

Also regarding using rectangular and polar values of current and voltages 442, the following line flow constraints can be used:

I_{n,m}^{r}·I_{n,m}^{r}+I_{n,m}ⁱ·I_{n,m}ⁱ≦|I_{n,m}^{max}|² (14)

where I_{n,m}^{max} represents the maximum line flow constraint from node n to node m. Line flows in terms of node voltages can be written as follows:

$$[ \begin{matrix}{I}_{n , m}^{r} \\ {I}_{n , m}^{i}\end{matrix} ] = [ \begin{matrix}{G}_{n , m} & - {B}_{n , m} \\ {B}_{n , m} & {G}_{n , m}\end{matrix} ] [ \begin{matrix}{V}_{n}^{r} - {V}_{m}^{r} \\ {V}_{n}^{i} - {V}_{m}^{i}\end{matrix} ] \qquad ( 15 )$$

Further regarding the modeling of DERs and RERs 443, in an embodiment, active and reactive power of components (e.g., capacitors, loads, solar PV) can be represented in terms of the real and imaginary parts of their currents and associated bus voltages at each phase as follows:

P=v^{r}i^{r}+vⁱiⁱ (16)

Q=vⁱi^{r}−v^{r}iⁱ (17)

Further regarding the optimization formulation for ESS placement and sizing 444, in an embodiment, we place an Energy Storage System with unlimited size on all nodes of the network, then run the model 411 to decide if a given Energy Storage System is scheduled or not, then update the list of viable Energy Storage Systems based on their charge and discharge power and energy storage level to decide on the best placement, sizing, and operation of the Energy Storage Systems.

Further regarding the optimization techniques 412, the optimization of the present principles can be modeled as a Non-Linear Programming (NPL) optimization 450 and/or a definite programming optimization 460. The proposed model can be used to optimally place, size, and operate Energy Storage Systems in an unbalanced distribution feeder with or without any of the following: PVs and DERs penetration in the distribution feeder; integration of concentrated ESS in the feeder, PVs, and DERs, and Energy Storage Systems integrated together in the feeder; and uncertainties in the load and solar PV generation.

Further regarding the NLP optimization 450, in an embodiment, the following objective functions can be considered for the single objective NLP model 451: (1) maximizing customer revenue; (2) minimizing total losses in the system; (3) minimizing the total energy drawn from the substation; (4) minimizing the unbalanced power between phases; and (5) minimizing the peak demand.

Further regarding the NLP optimization 450, in an embodiment, any combination of the following objectives can be used for the multi-objective NLP optimization model 452: (1) minimizing the cost of losses; (2) maximizing the revenue generated; (3) minimizing the total energy drawn from the substation; (4) minimizing the unbalanced power between phases; (5) minimizing the peak demand; and (6) more objective functions can be incorporated from different perspectives for utility and the customer.

Further regarding the applications 413, the present principles can be applied to the following exemplary applications:

(1) Various perspectives of ESS placement, sizing, and operation can be examined by taking conflicting objectives into account.

(2) Integrating distributed energy resources and ESS in a DOPF framework can be used for various applications.

(3) The method presented in this invention can be used in transmission system level ESS placement, sizing, and operation scheduling.

A description will now be given regarding some of the many attendant advantages of the present principles over the prior art as well as differences there between, in accordance with an embodiment of the present principles. One advantage is the providing of a novel optimization based modeling for integrated placement, sizing, and optimal operation scheduling of Energy Storage Systems in a distribution system that captures both radial and meshed networks, balanced or unbalanced feeders, losses, and operational constraints of power distribution networks and other components. Another advantage is that the present principles provide for the integration of a new formulation of the unbalanced distribution system optimal power flow to lessen solution time in the placement, sizing, and operation scheduling of Energy Storage Systems. Yet another advantage is the proposed approach for adding and removing Energy Storage Systems to and from a list of viable Energy Storage Systems.

A description will now be given of some of the many attendant competitive/competitive values of the present principles. One value is the providing of a novel integrated framework for co-optimization of optimal placement, sizing, and operation of ESS in distribution networks and microgrids. Another value is the providing of a detailed mathematical optimization modeling of the network connections, distributed energy resources, renewable energy resources, and ESS that capture the operational aspects as well as power flow requirements of these components. Yet another value is that the present principles determine the optimal places, size, and operation schedule of Energy Storage Systems in coordination with the networks' existing resources such as regulators, tap changers, capacitors, and distributed generation. This results in better economic solutions, improvement in reliability of distribution network, and enhancement in efficiency of networks' operations. Still another advantage is that the present principles provide a more accurate solution than any prior art approaches since the models are proposed on a per-phase basis, advantageously representing the unbalanced nature of distribution system. A further advantage is that the present principles generate better results than any prior art approaches in terms of lowering power losses, reducing energy imported from the grid, decreasing peak demand of the system, providing a better voltage profile across the distribution network, and lower peak to average ratio for system demand profile.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A method, comprising:
co-optimizing a placement, a sizing, and an operation schedule of at least one energy storage system in an energy distribution system, the energy distribution system further having at least one renewable energy resource and at least one distributed energy resource,
wherein said co-optimizing step comprises:
generating a placement-sizing-scheduling co-optimization model of the at least one energy storage system by integrating therein a distribution optimal power flow optimization model of the energy distribution system and components thereof, the distribution optimal power flow optimization model integrating therein at least an energy storage system model modeling the at least one energy storage system, a renewable energy resource model modeling the at least one renewable energy resource, and a distributed energy resource model modeling the at least one distributed energy resource; and
optimally determining, using a processor-based placement-sizing-scheduling optimizer, the placement, the sizing, and the operation schedule of the at least one energy storage system based on the placement-sizing-scheduling co-optimization model.

2. The method of claim 1, wherein the placement-sizing-scheduling optimization model further integrates therein operation benefits and a total cost of installing the at least one energy storage system at a particular location, with a particular size, and operating the at least one energy storage system in accordance with a particular operation schedule or policy.

3. The method of claim 1, wherein the energy storage system model models an acceptable operating region, active power outputs, and reactive power outputs of the at least one energy storage system.

4. The method of claim 1, wherein said determining step is performed to optimize one or more objective functions corresponding to the energy distribution system.

5. The method of claim 4, wherein the one or more objective functions include modeled converter losses for the at least one energy storage system.

6. The method of claim 4, wherein the one or more objective functions include modeled peak demand constraints on the energy distribution system at specific nodes thereof.

7. The method of claim 4, wherein the one or more objective functions consider unbalanced power at a point of connection in the energy distribution system.

8. The method of claim 1, wherein said generating step generates the distribution optimal power flow optimization model by further integrating therein at least one of system load data, a system load forecast, energy price data, an energy price forecast, weather data, and a weather forecast.

9. The method of claim 1, wherein said generating step generates the distribution optimal power flow optimization model by further integrating therein energy distribution system reliability-based operational constraints.

10. The method of claim 1, wherein the distribution optimal power flow optimization model is generated as an unbalanced multi-phase distribution optimal power flow optimization model.

11. The method of claim 1, wherein the operation schedule specifies an optimal charging, discharging, and idling schedule for the at least one energy storage system.

12. The method of claim 1, wherein the energy storage system model comprises charge constraints, discharge constraints and ramp constraints of the at least one energy storage system.

13. The method of claim 1, wherein the energy storage system model models round trip losses of the at least one energy storage system due to active and reactive power.

14. A non-transitory article of manufacture tangibly embodying a computer readable program which when executed causes a computer to perform the steps of claim 1.

15. A co-optimization system for co-optimizing a placement, a sizing, and an operation schedule of at least one energy storage system in an energy distribution system, the energy distribution system further having at least one renewable energy resource and at least one distributed energy resource, the co-optimization system comprising:
a memory; and
at least one processor device, coupled to the memory, operative to:
generate a placement-sizing-scheduling co-optimization model of the at least one energy storage system by integrating therein a distribution optimal power flow optimization model of the energy distribution system and components thereof, the distribution optimal power flow optimization model integrating therein at least an energy storage system model modeling the at least one energy storage system, a renewable energy resource model modeling the at least one renewable energy resource, and a distributed energy resource model modeling the at least one distributed energy resource; and
optimally determine the placement, the sizing, and the operation schedule of the at least one energy storage system based on the placement-sizing-scheduling co-optimization model.

16. The co-optimization system of claim 15, wherein the placement-sizing-scheduling optimization model further integrates therein operation benefits and a total cost of installing the at least one energy storage system at a particular location, with a particular size, and operating the at least one energy storage system in accordance with a particular operation schedule or policy.

17. The co-optimization system of claim 15, wherein the energy storage system model models an acceptable operating region, active power outputs, and reactive power outputs of the at least one energy storage system.

18. The co-optimization system of claim 15, wherein the placement, the sizing, and the operation schedule of the at least one energy storage system is determined by optimizing one or more objective functions corresponding to the energy distribution system.

19. The co-optimization system of claim 18, wherein the one or more objective functions include modeled converter losses for the at least one energy storage system.

20. The co-optimization system of claim 18, wherein the one or more objective functions include modeled peak demand constraints on the energy distribution system at various specific nodes thereof.
